(19) United States
(12) Patent Application Publication
(10) Pub. No.: US 2025/0390071 A1
(43) Pub. Date: Dec. 25, 2025

(54) ELECTRICITY CONSUMPTION MANAGEMENT METHOD AND SYSTEM

(71) Applicant: WISTRON CORPORATION, New Taipei City (TW)

(72) Inventor: Ting Ru YANG, New Taipei City (TW)

(73) Assignee: WISTRON CORPORATION, New Taipei City (TW)

(21) Appl. No.: 18/958,150

(22) Filed: Nov. 25, 2024

(30) Foreign Application Priority Data
Jun. 21, 2024 (TW) 113123070

(51) Int. Cl. G05B 13/04; H02J 3/00; H02J 13/00

(52) U.S. Cl. CPC G05B 13/048; H02J 3/003; H02J 13/00001; H02J 2203/20

(57) ABSTRACT

The disclosure provides an electricity consumption management method and an electricity consumption management system. The method includes the following steps. Historical electricity consumption data of an electricity field is obtained. A plurality of target feature variables are determined by performing feature selection based on the historical electricity consumption data. An electricity baseline prediction model using the plurality of target feature variables is established based on the historical electricity consumption data. The electricity consumption baseline prediction model is a quantile regression model. The target percentile of the quantile regression model is determined by comparing actual electricity consumptions of the electricity field with first baseline electricity consumptions predicted by the electricity baseline prediction model. A second baseline electricity consumptions for a unit period is predicted based on the target percentile using the electricity consumption baseline prediction model, and electricity management function is performed based on the second baseline electricity consumption.

### CROSS-REFERENCE TO RELATED APPLICATION

This application claims the priority and benefit of Taiwan Application No. 113123070, filed on Jun. 21, 2024, the disclosure of which is hereby incorporated in its entirety by reference herein.

### Technical Field

The disclosure relates to an electricity consumption analysis method, and particularly to an electricity consumption management method and system.

### BACKGROUND

### Description of Related Art

Energy conservation is an important issue related to environmental sustainability and energy efficiency. As environmental issues such as greenhouse gas reduction and energy conservation and carbon reduction receive increasing attention, the importance of energy conservation in various fields has become increasingly prominent. If the causes of electricity waste can be identified out effectively and appropriate energy-saving methods can be implemented, it will not only contribute to environmental protection but also significantly reduce electricity costs.

Traditional electricity consumption management methods face several major challenges, such as electricity waste, delayed detection, and difficulty in achieving annual targets.

### SUMMARY

The disclosure provides an electricity consumption management method and system.

An embodiment of the disclosure provides an electricity consumption management method, which includes the following steps. Historical electricity consumption data of an electricity field is obtained. Feature selection is performed based on the historical electricity consumption data to determine a plurality of target feature variables. Based on the historical electricity consumption data, an electricity consumption baseline prediction model using the plurality of target feature variables is established. The electricity consumption baseline prediction model is a quantile regression model. A target percentile of the quantile regression model is determined by comparing a plurality of actual electricity consumptions in the electricity field with a plurality of first baseline electricity consumptions predicted by the electricity consumption baseline prediction model. The electricity consumption baseline prediction model is used to predict the second baseline electricity consumption for a unit period according to the target percentile, An electricity management function is performed based on the second baseline electricity consumption.

An embodiment of the disclosure provides an electricity consumption management system, which includes a storage device and a processor. The storage device stores multiple instructions. The processor is coupled to the storage device, accesses the aforementioned instructions, and is configured to perform the following operations. Historical electricity consumption data of an electricity field is obtained. Feature selection is performed based on historical electricity consumption data to determine a plurality of target feature variables. Based on the historical electricity consumption data, an electricity consumption baseline prediction model using the plurality of target feature variables is established. The electricity consumption baseline prediction model is a Quantile Regression model. A target percentile of the quantile regression model is determined by comparing a plurality of actual electricity consumptions in the electricity field with a plurality of first baseline electricity consumptions predicted by the electricity consumption baseline prediction model. The electricity consumption baseline prediction model is used to predict the second baseline electricity consumption for a unit period according to the target percentile. An electricity management function is performed based on the second baseline electricity consumption.

Based on the above, in the embodiment of the disclosure, after selecting a plurality of target feature variables, these target feature variables can be used to establish an electricity consumption baseline prediction model based on the historical electricity consumption data. The electricity consumption baseline prediction model is a quantile regression model. The target percentile of the quantile regression model may be determined by comparing multiple actual electricity consumptions with multiple first baseline electricity consumptions predicted by the electricity consumption baseline prediction model. When the electricity consumption baseline prediction model is actually applied, the electricity consumption baseline prediction model may estimate the baseline electricity consumption for a unit period based on the target percentile, and use the baseline electricity consumption as the electricity consumption baseline to perform electricity consumption management function.

### BRIEF DESCRIPTION OF THE DRAWINGS

FIG. 1 is a schematic diagram of an electricity consumption management system according to an embodiment of the disclosure.

FIG. 2 is a flow chart of an electricity consumption management method according to an embodiment of the disclosure.

FIG. 3 is a schematic diagram of a visual interface according to an embodiment of the disclosure.

FIG. 4 is a flow chart of an electricity consumption management method according to an embodiment of the disclosure.

FIG. 5 is a schematic diagram illustrating the acquisition of multiple target feature variables according to an embodiment of the disclosure.

FIG. 6 is a schematic diagram of determining a target percentile according to an embodiment of the disclosure.

FIG. 7 is a schematic diagram of a visual interface according to an embodiment of the disclosure.

### DETAILED DESCRIPTION

Some embodiments of the disclosure accompanied with drawings are described in detail as follows. The reference numerals in the following description are regarded to represent the same or similar elements when the same reference numeral appears in the different drawings. These embodiments are only a part of the disclosure, and do not disclose all possible implementation manners of the disclosure. More precisely, these embodiments are just examples of the apparatuses and method of the disclosure that are within the scope of the application.

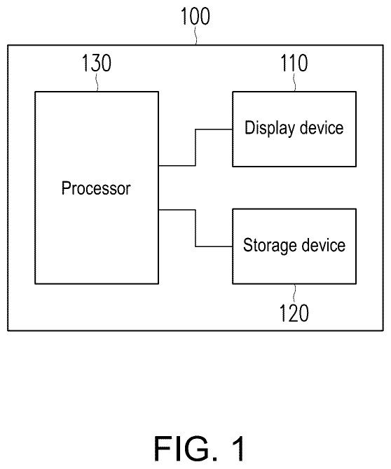

Referring to FIG. 1, which is a schematic diagram of an electricity consumption management system according to an embodiment of the disclosure. In various embodiments, the electricity consumption management system 100 may be implemented by one or more computing devices, such as laptops, desktop computers, servers, workstations, etc. with computing capabilities, but the disclosure is not limited thereto. The electricity consumption management system 100 may include a display device 110, a storage device 120, and a processor 130. The electricity consumption management system 100 is applied to factories, hospitals, shopping malls, schools, etc., but the disclosure is not limited thereto.

The display device 110 may be, for example, various types of displays such as a Liquid Crystal Display (LCD), a Light Emitting Diode (LED) display, an Organic Light Emitting Diode (OLED), etc., but the disclosure is not limited thereto. The display device 110 may be used to display a visual interface.

The storage device 120 may be, for example, any type of fixed or removable random access memory (RAM), read-only memory (ROM), flash memory, hard disk or other similar device, or a combination of such devices, which may be configured to record programming code or software modules.

The processor 130 may be, for example, a central processing unit (CPU), an application processor (AP), or other programmable general-purpose or special-purpose microprocessor (microprocessor) or digital signal processor (DSP), image signal processor (ISP), graphics processing unit (GPU) or other similar devices, integrated circuits and combinations thereof. The processor 130 can access and execute the software module recorded in the storage device 120 to implement the electricity consumption management method in the embodiment of the disclosure. The software modules described above may be broadly construed to mean instructions, instruction sets, code, programming code, programs, applications, software packages, threads, processes, functions, etc., whether referred to as software, firmware, middleware, microcode, hardware description language, or others.

In an embodiment of the disclosure, the processor 130 may establish an electricity consumption baseline prediction model based on historical electricity consumption data of an electricity field, and the trained electricity consumption baseline prediction model may be recorded in the storage device 120. That is, the electricity consumption baseline prediction model is a prediction model established by the processor 130 to estimate the electricity consumption baseline after performing machine learning or statistical calculations based on the training data set, and the electricity consumption baseline prediction model may output the baseline electricity consumption which is a forecast value based on past electricity consumption patterns within a historical period. The baseline electricity consumption predicted by the electricity consumption baseline prediction model established based on past electricity consumption patterns and historical electricity consumption data may be used as an electricity consumption assessment benchmark. That is, by comparing the actual electricity consumptions with the baseline electricity consumptions predicted by the electricity consumption baseline prediction model, whether the use of electric energy exceeds the expected range may be determined, thereby helping to identify energy saving opportunities and formulate energy saving measures.

In addition, in some embodiments, the processor 130 may divide the electricity consumption of the electricity field into multiple electricity consumption categories, and the processor 130 may establish a dedicated electricity consumption baseline prediction model for each electricity consumption category. Each electricity field may customize the electricity consumption categories to focus on based on its own management needs. For example, electricity consumption in a factory may be divided into various categories of electricity consumption. The electricity consumption categories include, for example, air compressor electricity consumption, air conditioning electricity consumption, lighting electricity consumption, production electricity consumption, basic electricity consumption, etc., but the disclosure is not limited thereto. For example, the processor 130 may establish a dedicated electricity consumption baseline prediction model for the factory's air compressor electricity consumption, and establish another dedicated electricity consumption baseline prediction model for the factory's air conditioning electricity consumption. In this way, when the total electricity consumption is abnormally high, by understanding the electric usage status of each electricity consumption category, it may be diagnosed which electricity consumption categories may have abnormal waste.

Alternatively, in some embodiments, when multiple different manufacturing processes operate in a factory, the electricity consumption category of the factory may include a first electricity consumption category corresponding to the first manufacturing process and a second electricity consumption category corresponding to the second manufacturing process. These processes may be, for example, Dual in Line Package Process (DIP Process) and Surface Mount Technology Process (SMT Process), but the disclosure is not limited thereto. In addition, after the processor 130 establishes multiple electricity consumption baseline prediction models for different manufacturing processes, the prediction results of these electricity consumption baseline prediction models may be added to obtain the electricity consumption baseline of the manufacturing process electricity consumption.

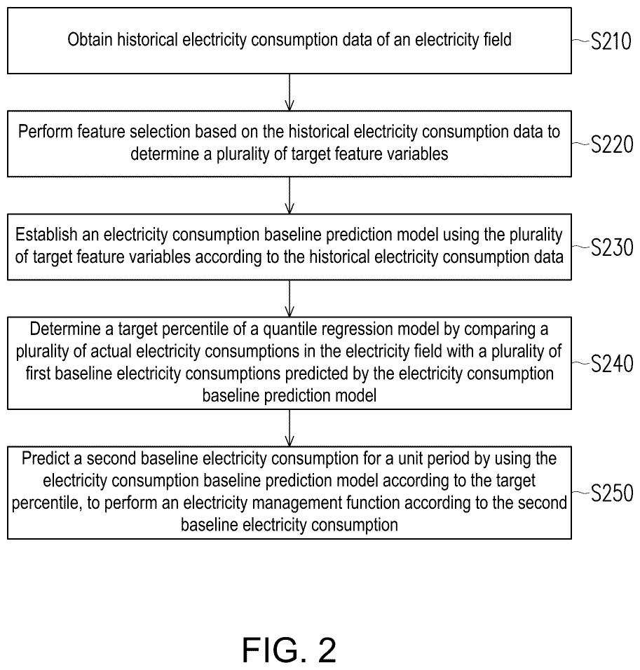

FIG. 2 is a flow chart of an electricity consumption management method according to an embodiment of the disclosure. Referring to FIG. 1 and FIG. 2, the method of the embodiment is applicable to the electricity consumption management system 100 in the above embodiment. The details of the electricity consumption management method of the embodiment may be described below with each component in the electricity consumption management system 100.

In step S210, the processor 130 may obtain historical electricity consumption data of an electricity field. The above-mentioned electricity fields may be, for example, factories, hospitals, shopping malls, schools, etc., but the disclosure is not limited thereto. The historical electricity consumption data may include actual electricity consumption in multiple historical unit periods and multiple potential feature variables that may affect electricity consumption. Multiple potential feature variables in historical electricity consumption data may include equipment operation information of electrical equipment, environmental information, weather information, or time information, etc. The length of the historical unit period may be one hour, one day, one month, one year, etc. The equipment operation information of the electrical equipment may be obtained by sensing with sensors or measuring instruments. The above-mentioned sensors or measuring instruments may include electric meters, thermometers, hygrometers, pressure gauges, etc., but the disclosure is not limited thereto. In some embodiments, the processor 130 may obtain historical electricity consumption data from sensors or measuring instruments configured in the electricity field, or may also receive historical electricity consumption data input by managers.

For example, when the processor 130 is configured to establish an electricity consumption baseline prediction model for a specific manufacturing process and the electricity consumption baseline prediction model is utilized to predict the electricity consumption for one hour, the processor 130 may collect the actual electricity consumption of the specific manufacturing process in each hour, ambient temperature in each hour, equipment parameters in each hour, production amount in each hour, and the number of process lines opened in each hour, etc.

In step S220, the processor 130 may perform feature selection based on the historical electricity consumption data to determine a plurality of target feature variables. The processor 130 may select a plurality of target feature variables from a plurality of potential feature variables based on a plurality of feature selection algorithms in feature engineering. These feature selection algorithms may include a Stepwise Method, a Shrinkage Method, a Regularization Method, or a Principal Component Analysis (PCA) method in statistical methods. Alternatively, these feature selection algorithms may include permutation feature importance methods in machine learning methods, such as selecting feature variables based on their importance through machine learning models such as random forests and gradient boosting trees. Alternatively, these feature selection algorithms may include feature selection methods based on feature weight in deep learning methods.

It should be noted that when establishing an electricity consumption baseline prediction model for a specific electricity consumption category, the processor 130 may perform data collection and feature selection for the specific electricity consumption category. That is to say, for different electricity consumption categories, the processor 130 may select different target feature variables.

In step S230, the processor 130 may establish an electricity consumption baseline prediction model using the plurality of target feature variables according to the historical electricity consumption data. The electricity consumption baseline prediction model is a Quantile Regression model. Specifically, in order to achieve effective management of electricity consumption, it is necessary to estimate the upper limit of the electricity consumption baseline under specific conditions. Therefore, in the embodiment of the disclosure, the processor 130 may use the quantile regression model to implement the electricity consumption baseline prediction model. The task of the quantile regression model is to predict the value of the dependent variable at different percentiles based on the independent variables. A quantile regression model can estimate the value of the dependent variable at different percentiles under given conditions (i.e., given independent variables). By fitting the quantile regression model to the target feature variables in the historical electricity consumption data, the processor 130 can determine the model parameters of the quantile regression model. These model parameters can include, for example, the slope and intercept in linear quantile regression or the curve parameters in nonlinear quantile regression.

In step S240, the processor 130 may determine a target percentile of the quantile regression model by comparing a plurality of actual electricity consumptions in the electricity field with a plurality of first baseline electricity consumptions predicted by the electricity consumption baseline prediction model. Specifically, the processor 130 needs to set a target percentile so that an appropriate electricity consumption baseline may be generated based on the target percentile using the electricity consumption baseline prediction model.

In an embodiment of the disclosure, after completing the training of the quantile regression model, the processor 130 may use the quantile regression model to generate a plurality of first baseline electricity consumptions. The processor 130 may compare multiple actual electricity consumptions of multiple historical unit periods with the first baseline electricity consumptions of the historical unit periods, and determine a target percentile of the quantile regression model based on the comparison results. Furthermore, in the embodiment of the disclosure, since the target percentile is determined based on the comparison between the model prediction results of the electricity consumption baseline prediction model and the actual electricity consumption, the prediction results of the electricity consumption baseline may be more accurate. This is because the model prediction results and the actual electricity consumption naturally adapt to seasonal variations.

In some embodiments, the processor 130 may obtain actual electricity consumptions within historical unit periods. The actual electricity consumptions may be provided to the processor 130 by the factory electric meter, or the actual electricity consumption measured by the factory electric meter may be input to the electricity consumption management system 100 by the manager. In addition, the processor 130 may input the plurality of target feature variables of each historical unit period into the electricity consumption baseline prediction model, so that the electricity consumption baseline prediction model may output a plurality of first baseline electricity consumptions corresponding to different preset percentiles. The processor 130 may select a target percentile of the quantile regression model based on comparison results between the first baseline electricity consumptions corresponding to the preset percentiles and the corresponding actual electricity consumptions. The preset percentiles are, for example, 10%, 20%, 30%, 40%, 50%, 60%, 70%, 80%, 90%, and 100%.

For example, the processor 130 may generate a plurality of first baseline electricity consumptions in January based on the plurality of target feature variables in January and the trained electricity consumption baseline prediction model, and the first baseline electricity consumptions in January are corresponding to multiple preset percentiles respectively. Afterwards, the processor 130 may compare the first baseline electricity consumptions in January with the actual electricity consumption in January, and obtain the comparison results in January. Similarly, the processor 130 may perform similar operations according to the plurality of target feature variables from February to June. Then, the processor 130 may determine the target percentile based on the comparison results from January to June. In some embodiments, the comparison results may include error parameters between a plurality of first baseline electricity consumptions and a plurality of actual electricity consumptions. In addition, in some embodiments, the above comparison results may also include the number of occurrences in which the first baseline electricity consumptions output by the model is greater than the corresponding actual electricity consumptions.

In step S250, the processor 130 may predict a second baseline electricity consumption for a unit period by using the electricity consumption baseline prediction model according to the target percentile, then the processor 130 may perform an electricity management function according to the second baseline electricity consumption. For example, assuming that the processor 130 determines that the target quantile is 60%, the processor 130 uses a quantile regression model to predict the second baseline electricity consumptions in a certain unit period based on the 60% percentile. Specifically, the processor 130 may estimate the second baseline electricity consumption of a unit period through an electricity consumption baseline prediction model based on a plurality of target feature variables within the unit period. The length of a unit period may be one month, one week, one day, one hour, one minute, etc., and the disclosure is not limited thereto. The processor 130 may establish an electricity consumption baseline prediction model based on a plurality of target feature variables of multiple historical unit periods before a specific time point. The processor 130 may predict a baseline electricity consumption for a certain electricity consumption category based on the electricity consumption baseline prediction model and the plurality of target feature variables of a unit period following the specific time point. For example, the processor 130 may establish an electricity consumption baseline prediction model based on a plurality of target feature variables of air conditioning electricity consumption in each month of 2023. Thereafter, the processor 130 may use the electricity consumption baseline prediction model to predict the baseline electricity consumption of air-conditioning in January 2024 based on the plurality of target feature variables in January 2024. Above-mentioned step S210, step S220, step S230, step S240 or step S250 is applied to the processor 130 of the electricity consumption management system of factories, hospitals, shopping malls, schools, etc., but the disclosure is not limited thereto.

In some embodiments, the processor 130 may utilize the display device 110 to display the second baseline electricity consumption in a visual interface. Furthermore, the display device 110 may display a visual interface, and the visual interface is an electricity consumption management interface. The electricity consumption management interface may present a plurality of baseline electricity consumptions and actual electricity consumptions of one or more electricity consumption categories. In some embodiments, the processor 130 may display the baseline electricity consumptions and the actual electricity consumptions through a graph on the electricity consumption management interface. In some embodiments, the above-mentioned graph may include line charts, bar charts, etc. Alternatively, in other embodiments, the processor 130 may also use a table to present the baseline electricity consumptions and the actual electricity consumptions in the electricity consumption management interface.

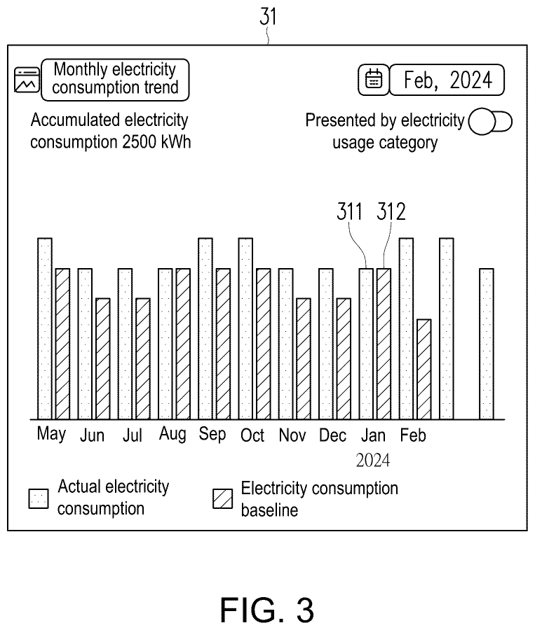

For example, referring to FIG. 3, which is a schematic diagram of a visual interface according to an embodiment of the disclosure. The processor 130 may display the visual interface 31 through the display device 110, and the visual interface 31 may present the baseline electricity consumptions and actual electricity consumptions in multiple unit periods. For example, the visual interface 31 includes a bar 312 representing the baseline electricity consumption in January and a bar 311 representing the actual electricity consumption in January.

In this way, managers may quickly understand the gap between the baseline electricity consumption of each unit period output by the electricity consumption baseline prediction model and the actual electricity consumption of each unit period by viewing the visual interface 31, and may roughly determine whether the electricity consumption status of each unit period meets expectations or if there are abnormal conditions. For example, if the actual electricity consumption in a given month is significantly higher than the baseline electricity consumption, it indicates abnormal energy usage in the electricity field. In such cases, the manager can promptly evaluate the electricity usage and address any anomalies. Thus, the embodiment may combine electricity consumption baseline prediction and visualization interface, which makes electricity monitoring and electricity strategy making easier and more intuitive. This solution helps managers better understand electricity usage, identify problems promptly, and manage and adjust accordingly, thereby improving energy efficiency and reducing electricity waste.

In some embodiments, the processor 130 may calculate a difference value between the second baseline electricity consumption and the actual electricity consumption in the same unit period, and perform the electricity management function based on the difference value. In some embodiments, the processor 130 may determine the effectiveness of the electricity saving project based on the above difference value. Alternatively, the processor 130 may also determine whether there is abnormal electricity consumption in the electricity field based on the above difference value. In some embodiments, the electricity management function may include controlling the interface display effect of the visual interface according to the difference value to prompt the manager. In one embodiment, in response to the difference value corresponding to a certain unit period being greater than the threshold, the processor 130 may highlight the baseline electricity consumption and the actual electricity consumption of the certain unit period in the visual interface.

Alternatively, in some embodiments, when the difference value corresponding to a certain unit period is greater than the threshold value and the actual electricity consumption is greater than the baseline electricity consumptions, the processor 130 may determine the cause of the electricity anomaly based on a plurality of target feature variables provided to the quantile regression model and actual operational parameters. For example, in practical operations, the processor 130 may identify that the actual electricity consumption in the SMT (Surface Mount Technology) process significantly exceeds the baseline electricity consumption. Through the application of the quantile regression model, the processor 130 can pinpoint that the temperature setting of a particular reflow oven is notably higher than expected. This results in higher electricity usage in that reflow oven than anticipated, thereby affecting the overall electricity consumption of the SMT process. Therefore, the processor 130 can use information from the quantile regression model to determine which reflow oven has a temperature setting significantly different and higher than the original set conditions. For instance, if reflow oven A is set at 280° C. while the quantile regression model suggests a setting of 260° C., the model would predict that the electricity consumption for the SMT process should fall within a specific range (i.e., below the electricity consumption baseline) when reflow oven A is at 260° C. However, if the actual electricity consumption exceeds the baseline, it indicates that the temperature setting of reflow oven A at 280° C. is too high, resulting in electricity wastage. Therefore, the processor 130 can advise managers to adjust reflow oven A's temperature setting to below 260° C. to align with the baseline setting. Through such adjustments, it reduces the electricity consumption of the SMT process and prevents further electricity wastage.

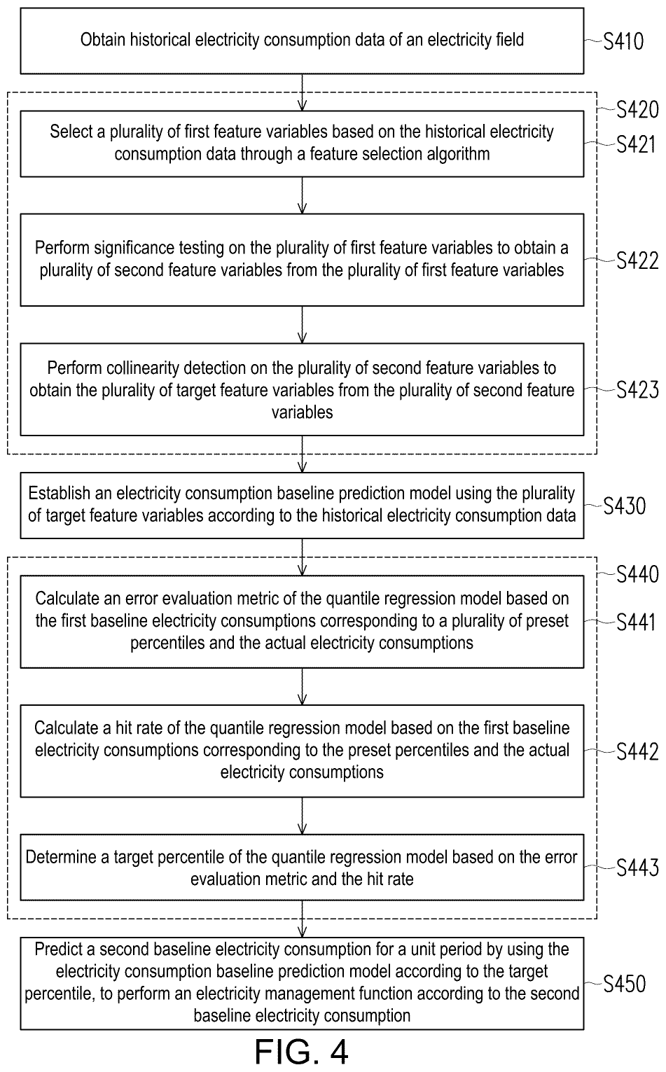

FIG. 4 is a flow chart of an electricity consumption management method according to an embodiment of the disclosure. Referring to FIG. 1 and FIG. 4, the method of the embodiment is applicable to the electricity consumption management system 100 in the above embodiment. The details of the electricity consumption management method of the embodiment may be described below with each component in the electricity consumption management system 100.

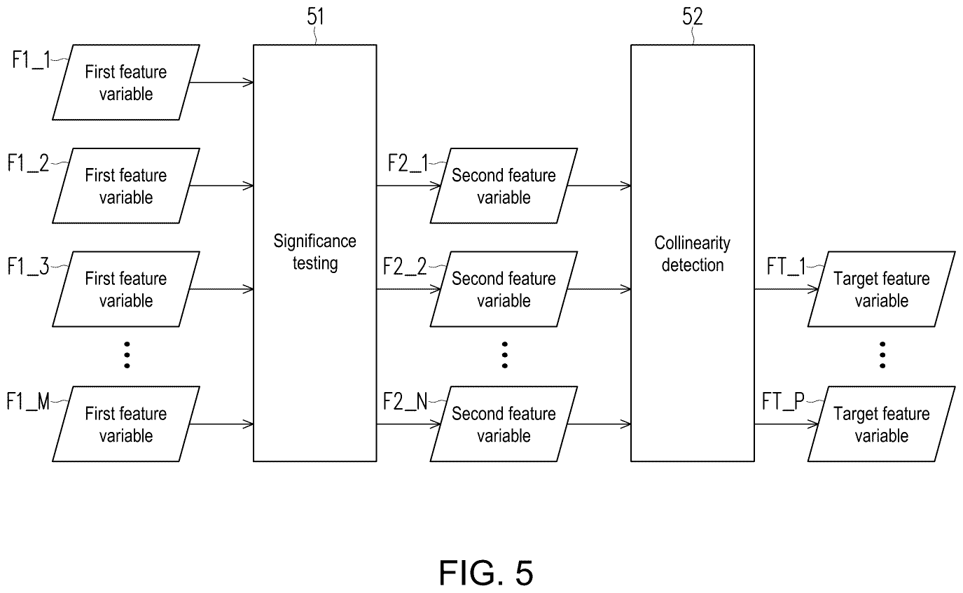

In step S410, the processor 130 may obtain historical electricity consumption data of an electricity field. In step S420, the processor 130 may perform feature selection based on the historical electricity consumption data to determine a plurality of target feature variables. In the embodiment of FIG. 4, step S420 may be implemented as steps S421 to S423. In addition, in order to clearly explain the principle of the disclosure, the implementation of determining multiple feature variables may be described below with reference to FIG. 5. Please also refer to FIG. 5, which is a schematic diagram of obtaining a plurality of target feature variables according to an embodiment of the disclosure.

In step S421, the processor 130 may select a plurality of first feature variables F1_1, F1_2, F1_3, . . . , F1_M based on the historical electricity consumption data through a feature selection algorithm. Specifically, the processor 130 may use the feature selection algorithm mentioned above to select a plurality of first feature variables F1_1 to F1_M.

In some embodiments, the processor 130 may select a plurality of first feature variables F1_1 to F1_M from the historical electricity consumption data according to a stepwise method. The processor 130 may gradually add feature variables that contribute to model predictions based on a model evaluation metric. The above model evaluation metric may be a Akaike Information Criterion. The smaller the AIC is, the better the model is. In the process of gradually increasing the feature variables, the processor 130 may observe the changes in AIC. When the processor 130 finds the model with the smallest AIC, the processor 130 may find a plurality of first feature variables F1_1 to F1_M.

However, the feature selection algorithm mentioned above still suffers from overfitting and collinearity problems. Specifically, too many feature variables may easily lead to model overfitting. In addition, collinearity among feature variables may also lead to parameter estimation errors in regression coefficients. Therefore, in some embodiments, the processor 130 may perform a further feature selection mechanism to select concise and reliable target feature variables from these first feature variables F1_1 to F1_M.

In step S422, the processor 130 may perform significance testing 51 on the plurality of first feature variables F1_1 to F1_M to obtain a plurality of second feature variables F2_1, F2_2, . . . , F2_N from the plurality of first feature variables F1_1 to F1_M. The significance test 51 is used to evaluate whether the plurality of first feature variables F1_1 to F1_M have a significant impact on the strain coefficient output by the model. Through the significance testing 51, the processor 130 may filter out N second feature variables F2_1, F2_2, . . . , F2_N from the M first feature variables F1_1 to F1_M, where NEM. In other words, the plurality of second feature variables F2_1 to F2_N may be a subset of the plurality of first feature variables F1_1 to F1_M.

In some embodiments, the processor 130 may calculate the significance P-value of each first feature variable F1_1 to F1_M. The processor 130 may obtain a plurality of second feature variables F2_1 to F2_N from the plurality of first feature variables F1_1 to F1_M according to a comparison result between the significance P value of each first feature variable F1_1 to F1_M and the first threshold value.

For example, when the significance P value of the first feature variable F1_1 is less than 0.05 (i.e., the first threshold value), it means that the first feature variable F1_1 has a significant impact on the strain coefficient output by the model, so the processor 130 may reserve the first feature variable F1_1 as one of the second feature variables F2_1 to F2_N. On the other hand, when the significance P value of the first feature variable F1_2 is greater than 0.05 (i.e., the first threshold value), it means that the first feature variable F1_2 has no significant impact on the strain coefficient output by the model, so the processor 130 excludes the first feature variable F1_2. In this way, through significance testing 51, variables that do not actually contribute to the model may be eliminated, thereby simplifying the model and improving the explanatory power.

In step S423, the processor 130 may perform collinearity detection 52 on the plurality of second feature variables F2_1 to F2_N to obtain a plurality of target feature variables FT_1, . . . , FT_P from the plurality of second feature variables F2_1 to F2_N. The collinearity detection 52 is used to evaluate whether there is a high degree of correlation between the plurality of second feature variables F2_1 to F2_N. Through the collinearity detection 52, the processor 130 may filter out P target feature variables FT_1 to FT_P from the N second feature variables F2_1 to F2_N, where P≤N. In other words, the plurality of target feature variables FT_1 to FT_P may be a subset of the plurality of second feature variables F2_1 to F2_N.

In some embodiments, the processor 130 may calculate a variation inflation factor (VIF) of each of the plurality of second feature variables F2_1 to F2_N. The larger the VIF value is, the more severe the collinearity is. The processor 130 may obtain a plurality of target feature variables FT_1 to FT_P from the plurality of second feature variables F2_1 to F2_N based on a comparison result of the variation inflation factor of each second feature variable F2_1 to F2_N and the second threshold value.

For example, when the VIF of the second feature variable F2_1 is greater than 10 (that is, the second threshold), it means that the second feature variable F2_1 is highly correlated with other second feature variables, so the processor 130 may exclude the second feature Variable F2_1 without retaining the second feature variable F2_1. On the other hand, when the VIF of the second feature variable F2_2 is less than 10 (i.e., the second threshold), the processor 130 may retain the second feature variable F2_2 as one of the target feature variables FT_1 to FT_P. In this way, through collinearity detection 52, duplicate information in the model may be avoided, thereby improving the stability and interpretability of the model.

In step S430, the processor 130 may establish an electricity consumption baseline prediction model using the plurality of target feature variables according to the historical electricity consumption data. The electricity consumption baseline prediction model is a Quantile Regression model. Next, in step S440, the processor 130 may determine a target percentile of the quantile regression model by comparing a plurality of actual electricity consumptions in the electricity field with a plurality of first baseline electricity consumptions predicted by the electricity consumption baseline prediction model. In the embodiment of FIG. 4, step S440 may be implemented as steps S441 to S443.

In step S441, the processor 130 may calculate an error evaluation metric of the quantile regression model based on a plurality of first baseline electricity consumptions and a plurality of actual electricity consumptions corresponding to a plurality of preset percentiles. The error evaluation metric may be mean absolute percentage error (MAPE). Alternatively, in some embodiments, the error evaluation metric may be mean absolute error (MAE). A lower error evaluation metric indicates that the model's predicted results are closer to the actual electricity consumption.

Specifically, the processor 130 may input the plurality of target feature variables of multiple historical unit periods into the electricity consumption baseline prediction model, and control the electricity consumption baseline prediction model to output multiple first baseline electricity consumptions corresponding to multiple preset percentiles. For example, the processor 130 may generate a plurality of first baseline electricity consumptions corresponding to a plurality of preset percentiles through the electricity consumption baseline prediction model according to the plurality of target feature variables in January, and may generate a plurality of first baseline electricity consumptions according to the plurality of target feature variables in February. Thereafter, the processor 130 may calculate the MAPE corresponding to the same preset percentile based on the differences between the first baseline electricity consumptions corresponding to different historical unit periods but the same preset percentile and actual electricity consumptions.

For example, the processor 130 may calculate the difference between the first baseline electricity consumption corresponding to the preset percentile 10% in January and the actual electricity consumption in January, and calculate the difference between the first baseline electricity consumption corresponding to the preset percentile 10% in February and the actual electricity consumption in February. Afterwards, the processor 130 may calculate the MAPE corresponding to the preset percentile 10% based on the above differences.

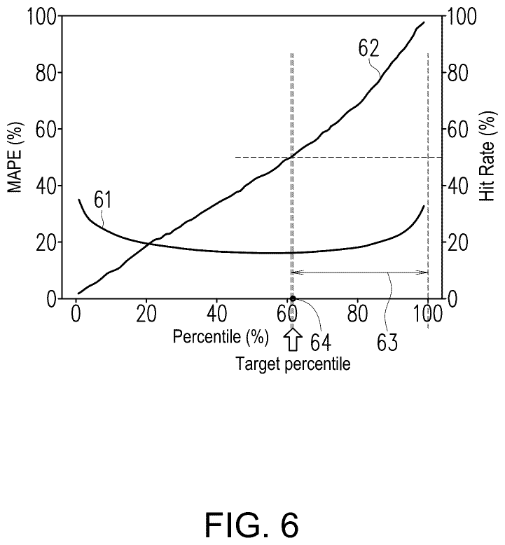

For example, FIG. 6 is a schematic diagram of determining a target percentile according to an embodiment of the disclosure. Referring to FIG. 6, based on the aforementioned operation method of calculating MAPE, the processor 130 may generate MAPE corresponding to different preset percentiles, and generate a MAPE curve 61 based on the MAPE corresponding to different preset percentiles. As shown in MAPE curve 61, as the percentile increases, MAPE may first decrease and then increase. The reason is that low percentiles may cause the electricity consumption baseline to be underestimated and cause errors. As the underestimation decreases and the electricity baseline becomes very close to the actual consumption, the MAPE reaches its lowest value. Subsequently, excessively high percentiles might cause an overestimation of the electricity baseline, resulting in errors and causing the MAPE to rise again.

In step S442, the processor 130 may calculate a hit rate of the quantile regression model based on a plurality of first baseline electricity consumptions and a plurality of actual electricity consumptions corresponding to a plurality of preset percentiles. In some embodiments, the hit rate is a ratio between a number of samples where the actual electricity consumption is greater than the first baseline electricity consumption and a total number of samples. Furthermore, the processor 130 may compare the actual electricity consumptions with the first baseline electricity consumptions month by month. and the hit rate is the ratio between the number of times the actual electricity consumptions are less than or equal to the first baseline electricity consumptions and the total number of comparisons. For example, the processor 130 may compare the actual electricity consumptions in the past five months with the first baseline electricity consumptions. Assuming that the actual electricity consumptions for 3 months is less than the first baseline electricity consumptions, the hit rate is 3/5=60%. In other words, when the hit rate is higher, it means that the actual electricity consumption usually does not exceed the electricity consumption baseline estimated by the model.

In addition, the processor 130 may generate a plurality of first baseline electricity consumptions corresponding to a plurality of preset percentiles through an electricity consumption baseline prediction model. By comparing these multiple first baseline electricity consumptions corresponding to multiple preset percentiles with the actual electricity consumptions, the processor 130 can calculate the hit rate corresponding to these preset percentiles.

Referring to FIG. 6 again, based on the aforementioned operation method of calculating the hit rate, the processor 130 may generate the hit rates corresponding to different preset percentiles, and generate hits rate curve 62 based on the hit rates corresponding to different preset percentiles. As shown in the hit rate curve 62, as the percentile increases, the increase in the electricity consumption baseline may cause the hit rate to increase accordingly. However, a high hit rate may mean that the electricity consumption baseline is overestimated.

In step S443, the processor 130 may determine the target percentile of the quantile regression model based on the error evaluation metric and the hit rate. Furthermore, based on the condition that a lower MAPE is better but the hit rate should not be too high or too low, the processor 130 may identify a target percentile that may not overestimate or underestimate the electricity consumption baseline. The rationale is that although a high hit rate indicates that the electricity consumption generally meets expectations and does not exceed the baseline, the high hit rate may also result from setting the baseline too high, thereby missing opportunities to optimize electricity usage and ignoring unnecessary electricity waste. Similarly, if the hit rate is too low, it means that the electricity consumption baseline is set too low, causing excessive false alarms about electricity waste, which is detrimental to electricity management. Therefore, the processor 130 may find the target percentile based on the condition that the hit rate may not be too high or too low.

In some embodiments, the processor 130 may determine the percentile search interval of the target percentile based on the hit rate. The hit rates of all percentiles within the percentile search interval are within a preset range. Furthermore, in order to ensure that the hit rate may not be too high or too low, the processor 130 may set a preset range of the hit rate and find the corresponding percentile search interval according to the preset range of the hit rate. For example, the preset range of the hit rate is greater than or equal to 50%, or between 40% and 60%. The processor 130 may then select a target percentile corresponding to the smallest error evaluation metric from the percentile search interval.

For example, referring to FIG. 6 again and assuming that the preset range of the hit rate is greater than or equal to 50%, the processor 130 may obtain the percentile search interval 63 according to the hit rate curve 62. The hit rates corresponding to all percentiles within the percentile search interval 63 are greater than or equal to 50%. Thereafter, the processor 130 may select the target percentile 64 corresponding to the smallest MAPE from the percentile search interval 63. In the example of FIG. 6, the target percentile 64 may be approximately 62%. Here, selecting the percentile corresponding to the minimum MAPE as the target percentile helps ensure the prediction accuracy of the model.

It may be seen that, by balancing the accuracy and practicality of the electricity consumption baseline, the processor 130 may automatically adjust and set the target percentile for estimating the electricity consumption baseline. By estimating the percentiles of electricity consumption under specific conditions, a more reliable electricity baseline is provided. This approach, unlike traditional methods that use past average electricity consumption, is more flexible. It can automatically adjust to appropriate percentiles, better addressing the effects of seasonal variations, making quantile regression effective in various scenarios.

In step S450, the processor 130 may use the electricity consumption baseline prediction model to predict the second baseline electricity consumption for the unit period according to the target percentile, so as to perform an electricity management function based on the second baseline electricity consumption. In some embodiments, the processor 130 may utilize the display device 110 to display a visual interface including the second baseline electricity consumption. The visual interface not only displays past and current electricity consumption status, but also predicts future electricity consumption targets based on the electricity consumption baseline prediction model. In addition, when the length of the unit period is 1 hour, the second baseline electricity consumption output by the electricity consumption baseline prediction model may be used as the hourly electricity consumption target value. By accumulating the second baseline electricity consumptions for multiple hours, the processor 130 may obtain a daily, monthly or yearly electricity consumption upper limits. In some embodiments, the processor 130 may use a visual interface to display the actual electricity consumptions and the second baseline electricity consumptions of different electricity consumption categories. Consequently, managers can identify sources of electricity waste by observing the visualization interface.

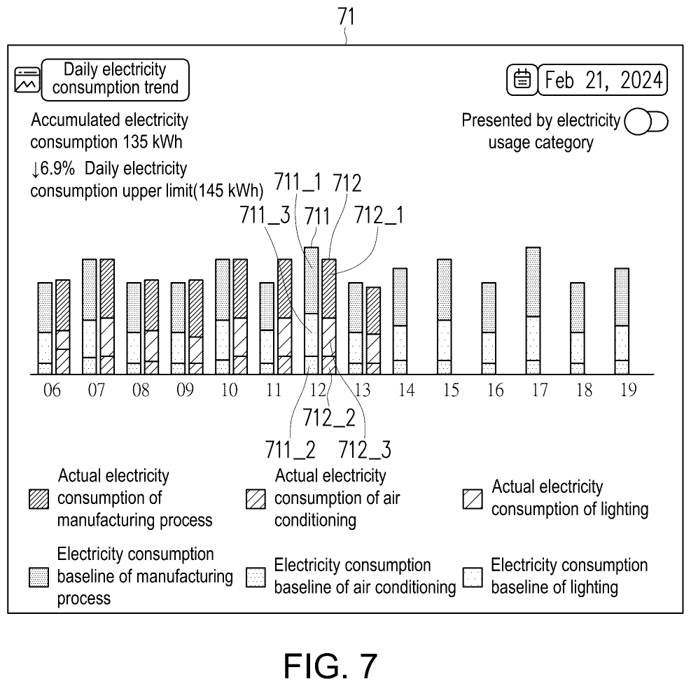

For example, FIG. 7 is a schematic diagram of a visual interface according to an embodiment of the disclosure. Referring to FIG. 7, the display device 110 may display the visual interface 71. The processor 130 may utilize the visualization interface 71 to present the bar chart. The bar chart includes bars for presenting a plurality of daily actual electricity consumptions and the second baseline electricity consumptions. For example, the bar 711 is used to display the second baseline electricity consumption on a certain day, and the bar 712 is used to display the actual electricity consumption on the same day.

In addition, the processor 130 can display the actual electricity consumptions and the second baseline electricity consumptions for different electricity consumption categories (such as manufacturing process electricity consumption, air conditioning electricity consumption, and lighting electricity consumption as shown in FIG. 7) through bar charts. For example, bar 711 includes the first stacked block 711_1 corresponding to manufacturing process electricity consumption, representing the second baseline electricity consumption for manufacturing process on a specific day. Bar 711 also includes the second stacked block 711_2 corresponding to air conditioning electricity consumption, representing the second baseline electricity consumption for air conditioning on the same day. Similarly, bar 711 includes the third stacked block 711_3 corresponding to lighting electricity consumption, representing the second baseline electricity consumption for lighting on that day. On the other hand, bar 712 includes the first stacked block 712_1 corresponding to manufacturing process electricity consumption, representing the actual electricity consumption for manufacturing process on the same day. Bar 712 also includes the second stacked block 712_2 corresponding to air conditioning electricity consumption, representing the actual electricity consumption for air conditioning on that day. Bar 712 also includes the third stacked block 712_3 corresponding to lighting electricity consumption, representing the actual electricity consumption for lighting on that day. Thus, by observing the visualization graphic interface 71, managers can determine which electricity consumption category exhibits abnormal consumption based on the electricity baseline. Additionally, by observing the visualization interface 71, managers can identify the time points of abnormal electricity consumption based on the electricity baseline (i.e., the multiple second baseline electricity consumption values output by the model). Above-mentioned step S410, step S420, step S421, step S422, step S423, step S430, step S440, step S441, step S442, step S443 or step S450 is applied to the processor 130 of the electricity consumption management system of factories, hospitals, shopping malls, schools, etc., but the disclosure is not limited thereto.

To sum up, in the embodiment of the disclosure, the electricity consumption baseline prediction model may be established according to the target feature variables. The electricity consumption baseline prediction model is a highly interpretable quantile regression model. The target percentile of the quantile regression model may be determined by comparing multiple actual electricity consumptions with multiple first baseline electricity consumptions predicted by the electricity consumption baseline prediction model. Therefore, when the electricity consumption baseline prediction model is actually applied, the electricity consumption baseline prediction model may estimate the baseline electricity consumption per unit period according to the target percentile, and use the baseline electricity consumption as the electricity consumption baseline to execute an electricity management function. Based on this, the overestimation or underestimation of the electricity consumption baseline may be avoided to improve the efficiency and accuracy of energy management. Based on good electricity consumption baseline estimation, electricity consumption management may be made more efficient and power waste may be effectively reduced.

In addition, the baseline electricity consumptions and actual electricity consumptions may be displayed on a visual interface for managers to view, allowing managers to evaluate the electricity consumption status for different periods of time. The difference between the baseline electricity consumption and the actual electricity consumption can further enable managers to promptly identify if any abnormal electricity consumption is occurring. Additionally, in this embodiment of the disclosure, different electricity baseline prediction models can be established for various electricity consumption categories. This helps managers more easily identify and address specific areas of abnormal electricity consumption and implement corrective measures.

Although the disclosure has been disclosed above through embodiments, they are not intended to limit the disclosure. Any person with ordinary knowledge in the relevant technical field may make some modifications and modifications without departing from the spirit and scope of the disclosure. Therefore, the protection scope of the disclosure shall be determined by the appended patent application scope.

What is claimed is:

1. An electricity consumption management method, comprising:
obtaining historical electricity consumption data of an electricity field;
performing feature selection based on the historical electricity consumption data to determine a plurality of target feature variables;
establishing an electricity consumption baseline prediction model using the plurality of target feature variables according to the historical electricity consumption data, wherein the electricity consumption baseline prediction model is a quantile regression model;
determining a target percentile of the quantile regression model by comparing a plurality of actual electricity consumptions in the electricity field with a plurality of first baseline electricity consumptions predicted by the electricity consumption baseline prediction model;
predicting a second baseline electricity consumption for a unit period by using the electricity consumption baseline prediction model according to the target percentile; and
performing an electricity management function according to the second baseline electricity consumption.

2. The electricity consumption management method according to claim 1, wherein the step of performing the feature selection based on the historical electricity consumption data to determine the plurality of target feature variables comprises:
selecting a plurality of first feature variables based on the historical electricity consumption data through a feature selection algorithm;
performing significance testing on the plurality of first feature variables to obtain a plurality of second feature variables from the plurality of first feature variables; and
performing collinearity detection on the plurality of second feature variables to obtain the plurality of target feature variables from the plurality of second feature variables.

3. The electricity consumption management method according to claim 2, wherein the step of performing the significance testing on the plurality of first feature variables to obtain the plurality of second feature variables from the plurality of first feature variables comprises:
calculating a significance P-value of each of the plurality of first feature variables; and
obtaining the plurality of second feature variables from the plurality of first feature variables according to a comparison result of the significance P value of each of the plurality of first feature variables and a first threshold value.

4. The electricity consumption management method according to claim 2, wherein the step of performing the collinearity detection on the plurality of second feature variables to obtain the plurality of target feature variables from the plurality of second feature variables comprises:
calculating a variation inflation factor (VIF) for each of the plurality of second feature variables; and
obtaining the plurality of target feature variables from the plurality of second feature variables according to a comparison result of the variation inflation factor of each of the plurality of second feature variables and a second threshold value.

5. The electricity consumption management method according to claim 1, wherein the step of determining the target percentile of the quantile regression model by comparing the plurality of actual electricity consumptions in the electricity field with the plurality of first baseline electricity consumptions predicted by the electricity consumption baseline prediction model comprises:
calculating an error evaluation metric of the quantile regression model based on the plurality of first baseline electricity consumptions corresponding to a plurality of preset percentiles and the plurality of actual electricity consumptions;
calculating a hit rate of the quantile regression model based on the plurality of first baseline electricity consumptions corresponding to the plurality of preset percentiles and the plurality of actual electricity consumptions; and
determining the target percentile of the quantile regression model based on the error evaluation metric and the hit rate.

6. The electricity consumption management method according to claim 5, wherein the step of determining the target percentile of the quantile regression model according to the error evaluation metric and the hit rate comprises:
determining a percentile search interval for the target percentile based on the hit rate; and
selecting the target percentile corresponding to the smallest error evaluation metric from the percentile search interval.

7. The electricity consumption management method according to claim 6, wherein the hit rates of all percentiles within the percentile search interval are within a preset range.

8. The electricity consumption management method according to claim 5, wherein the error evaluation metric comprises mean absolute percentage error (MAPE), and the hit rate is a ratio between a number of samples where the actual electricity consumption is greater than the first baseline electricity consumption and a total number of samples.

9. The electricity consumption management method according to claim 1, wherein the step of predicting the second baseline electricity consumption for the unit period by using the electricity consumption baseline prediction model according to the target percentile, or performing the electricity management function according to the second baseline electricity consumption comprises:
displaying the second baseline electricity consumption in a visual interface by using a display device.

10. The electricity consumption management method according to claim 1, wherein the step of performing the electricity management function according to the second baseline electricity consumption comprises:
calculating a difference value between the second baseline electricity consumption and the actual electricity consumption for the unit period; and
performing the electricity management function according to the difference value.

11. An electricity consumption management system, comprising:
a storage device, configured to store instructions; and
a processor, coupled to the storage device and configured to access the instructions to:
obtain historical electricity consumption data of an electricity field;
perform feature selection based on the historical electricity consumption data to determine a plurality of target feature variables;
establish an electricity consumption baseline prediction model using the plurality of target feature variables according to the historical electricity consumption data, wherein the electricity consumption baseline prediction model is a quantile regression model;
determine a target percentile of the quantile regression model by comparing a plurality of actual electricity consumptions in the electricity field with a plurality of first baseline electricity consumptions predicted by the electricity consumption baseline prediction model;
predict a second baseline electricity consumption for a unit period by using the electricity consumption baseline prediction model according to the target percentile; and
perform an electricity management function according to the second baseline electricity consumption.

12. The electricity consumption management system according to claim 11, wherein the processor is further configured to:
select a plurality of first feature variables based on the historical electricity consumption data through a feature selection algorithm;
perform significance testing on the plurality of first feature variables to obtain a plurality of second feature variables from the plurality of first feature variables; and
perform collinearity detection on the plurality of second feature variables to obtain the plurality of target feature variables from the plurality of second feature variables.

13. The electricity consumption management system according to claim 12, wherein the processor is further configured to:
calculate a significance P-value of each of the plurality of first feature variables; and
obtain the plurality of second feature variables from the plurality of first feature variables according to a comparison result of the significance P value of each of the plurality of first feature variables and a first threshold value.

14. The electricity consumption management system according to claim 12, wherein the processor is further configured to:
calculate a variation inflation factor (VIF) for each of the plurality of second feature variables; and
obtain the plurality of target feature variables from the plurality of second feature variables according to a comparison result of the variation inflation factor of each of the plurality of second feature variables and a second threshold value.

15. The electricity consumption management system according to claim 11, wherein the processor is further configured to:
calculate an error evaluation metric of the quantile regression model based on the plurality of first baseline electricity consumptions corresponding to a plurality of preset percentiles and the plurality of actual electricity consumptions;
calculate a hit rate of the quantile regression model based on the plurality of first baseline electricity consumptions corresponding to the plurality of preset percentiles and the plurality of actual electricity consumptions; and
determine the target percentile of the quantile regression model based on the error evaluation metric and the hit rate.

16. The electricity consumption management system according to claim 15, wherein the processor is further configured to:
determine a percentile search interval for the target percentile based on the hit rate; and
select the target percentile corresponding to the smallest error evaluation metric from the percentile search interval.

17. The electricity consumption management system according to claim 16, wherein the hit rates of all percentiles within the percentile search interval are within a preset range.

18. The electricity consumption management system according to claim 15, wherein the error evaluation metric comprises mean absolute percentage error (MAPE), and the hit rate is a ratio between a number of samples where the actual electricity consumption is greater than the first baseline electricity consumption and a total number of samples.

19. The electricity consumption management system according to claim 11, wherein the processor is further configured to:
display the second baseline electricity consumption in a visual interface by using a display device.

20. The electricity consumption management system according to claim 11, wherein the processor is further configured to:
calculate a difference value between the second baseline electricity consumption and the actual electricity consumption for the unit period; and
perform the electricity management function according to the difference value.
